(19) United States
(12) Patent Application Publication
(10) Pub. No.: US 2026/0118827 A1
(43) Pub. Date: Apr. 30, 2026

(54) TIMEPIECE

(71) Applicant: CASIO COMPUTER CO., LTD., Shibuya-ku (JP)

(72) Inventor: Tomohiro HAMAUE, Tokyo (JP)

(73) Assignee: CASIO COMPUTER CO., LTD., Shibuya-ku (JP)

(21) Appl. No.: 19/366,357

(22) Filed: Oct. 22, 2025

(30) Foreign Application Priority Data
Oct. 24, 2024 (JP) 2024-187311

(51) Int. Cl. G04B 37/00; G04B 19/18; G04B 39/00

(52) U.S. Cl. CPC G04B 37/0008; G04B 19/18; G04B 39/00

(57) ABSTRACT

A timepiece including: a case with an opening; and a first exterior located at the opening of the case. The first exterior includes a ring-shaped first member and a first protrusion protruding toward a center of the first member from a plurality of locations along a circumferential direction of the first member, and the first protrusion of the first exterior is located at an outermost location of the timepiece.

### BACKGROUND OF THE INVENTION

### Field of the Invention

The present disclosure relates to a timepiece.

### Description of the Related Art

For example, JP H01-141485 (U) describes a timepiece ("world timepiece”) with a rotatable bezel provided around a hand shaft to which a hand is attached, an outer bezel with the names of cities around the world painted on its surface, and an inner bezel provided on the inner circumference of the outer bezel, in which a plurality of hour characters are painted on the inner bezel.

### SUMMARY OF THE INVENTION

A timepiece according to an aspect of the present disclosure comprises:

a case with an opening; and

a first exterior located at the opening of the case, wherein

the first exterior includes a ring-shaped first member and a first protrusion protruding toward a center of the first member from a plurality of locations along a circumferential direction of the first member, and

the first protrusion of the first exterior is located at an outermost location of the timepiece.

### BRIEF DESCRIPTION OF THE DRAWINGS

FIG. 1 is a diagram of the key parts of a timepiece according to an embodiment.

FIG. 2 is a diagram of the timepiece according to the embodiment.

FIG. 3 is a front view of the timepiece according to the embodiment.

FIG. 4 is a side view of the timepiece at 3 o’clock side according to the embodiment.

FIG. 5 is a cross-sectional view along the V-V line shown in FIG. 3.

FIG. 6 is a cross-sectional view along the VI-VI line shown in FIG. 3.

FIG. 7 is a cross-sectional view along the VII-VII line shown in FIG. 3.

FIG. 8 is a front view of a timepiece according to a modification example.

FIG. 9 is a front view of a timepiece according to a modification example.

### DETAILED DESCRIPTION

Further features of the present invention will become apparent from the following description of exemplary embodiments (with reference to the attached drawings).

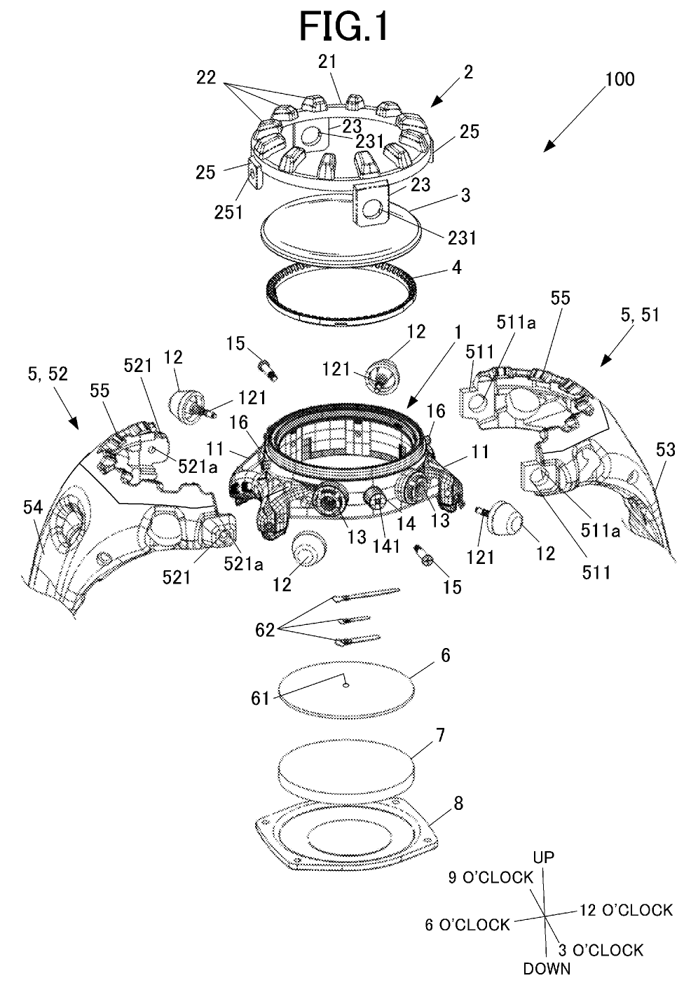

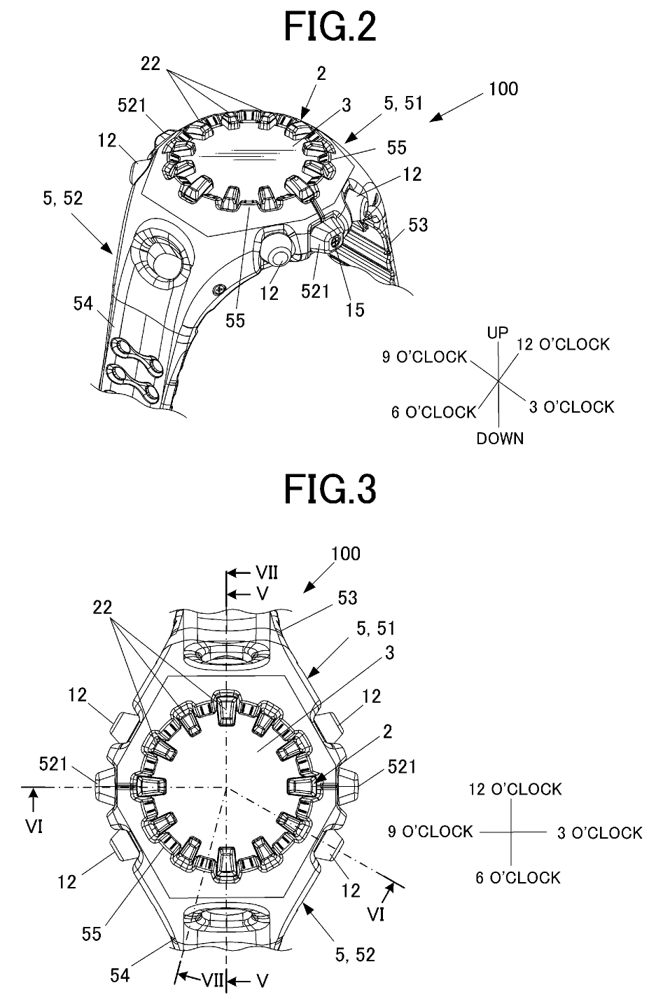

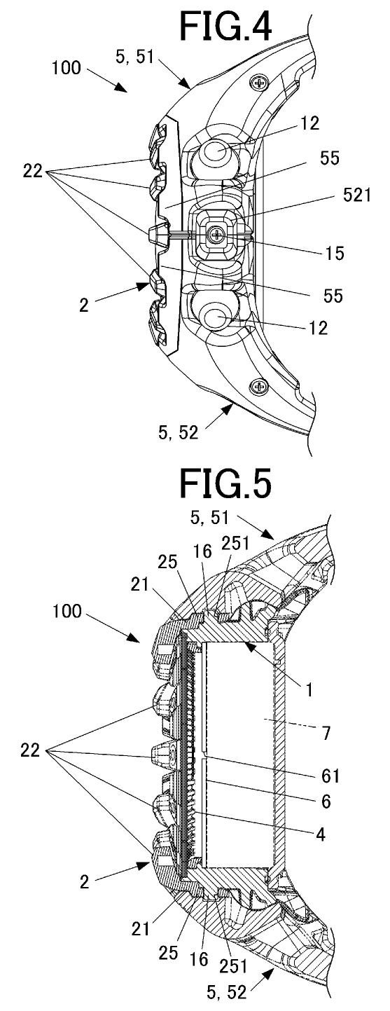

With reference to FIGS. 1 through 7, an embodiment of a timepiece in accordance with the present disclosure will be described. In the embodiment, a case in which the timepiece is a wristwatch that is worn on the wrist (hereinafter simply referred to as "timepiece 100”) is shown as an example. In the following, the "first direction" of the timepiece is the height direction (thickness direction) in the timepiece 100, which is the vertical direction in FIGS. 1 and 2. The "12 o’clock direction," "6 o’clock direction," "3 o’clock direction," and "9 o’clock direction" in FIGS. 1 through 3 refer to the respective directions in the analog timepiece display. The embodiment described below is provided with various limitations technically preferable for carrying out the present disclosure. However, the scope of the present disclosure is not limited to the embodiment below or illustrated examples.

The timepiece 100 has a case body 1 and a first exterior 2. As shown in FIG. 1, the case body 1 is a cylindrical member along the "first direction," the vertical direction, and is made of a metallic material such as stainless steel (SUS), titanium, or aluminum, for example. Although the case body 1 is preferably strong to some extent, the materials that make up the case body 1 are not limited to those illustrated here. The case body 1 may be made of various synthetic resins, for example. The illustration shows a case in which the case body 1 and the timepiece 100 equipped with the case body 1 are almost circular in plan view, but the shape of the case body 1 and the timepiece 100 is not limited to circular, and may be oval, rectangular, or other shapes. In the embodiment, the case body 1 is formed in the shape of a hollow short cylinder with openings at the top and bottom. The case body 1 has supports 11 at the 12 o'clock and 6 o'clock positions in an analog timepiece, which support a first part 51 and a second part 52 described below. As shown in FIGS. 1 to 4, operation buttons 12 can be attached to the outer circumferential surface of the case body 1 as appropriate, and insertion holes 13 are formed at the attachment locations of the operation buttons 12, which penetrate into the case body 1 and through which shaft portions 121 of the operation buttons 12 are inserted. The number and arrangement of operation buttons 12 are not limited, but in the embodiment, as shown in FIG. 1 and FIG. 3, operation buttons 12 are provided at four locations that are approximately the "2 o’clock position", "4 o’clock position", "8 o’clock position", and "10 o’clock position" in the timepiece 100.

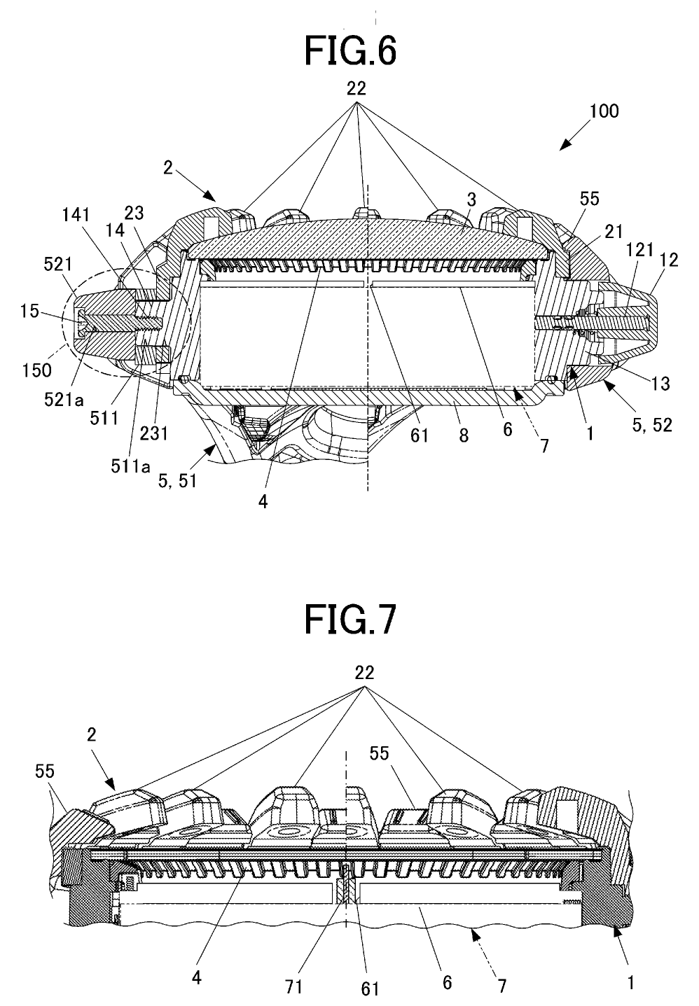

Furthermore, on the outer circumferential surface of the case body 1, at the "3 o’clock position" and "9 o’clock position" in the timepiece 100, screw fixing portions 14 are formed. In the embodiment, the screw fixing portion 14 is a projecting portion protruding outward from the outer circumferential surface of the case body 1, as shown in FIGS. 1 and 6. The screw fixing portion 14 is the portion where the first exterior 2 and second exterior 5 described below are screwed by screws 15. Specifically, the screw fixing portion 14 is shaped to allow the second protrusion 23 of the first exterior 2 and the first part 51 of the second exterior 5 to be fastened. In addition, a screw hole 141 is formed in the approximate center of the screw fixing portion 14, extending from the outside toward the inside (toward the case body 1) in the protruding direction of the screw fixing portion 14. In the embodiment, after the second protrusion 23 of the first exterior 2 and the first part 51 of the second exterior 5 are fastened to the screw fixing portion 14, the second part 52 of the second exterior 5 is placed and fixed by inserting screws 15 through the screw holes 141. This allows the first exterior 2 and second exterior 5 to be co-tightened to the case body 1.

On the outer circumferential surface of the case body 1, at locations different from the locations where the screw fixing portions 14 are provided, there are fastening projecting portions 16 for fastening the first exterior 2. Although the number and position of the screw fixing portions 14 and the fastening projecting portions 16 are not particularly limited, it is preferable that the screw fixing portions 14 and the fastening projecting portions 16 be arranged as evenly as possible in the circumferential direction of the case body 1 in order to fix the first exterior 2 more securely. In the embodiment, as shown in FIG. 1, the case in which the fastening projecting portion 16 is provided at the "12 o’clock position" and "6 o’clock position" in the timepiece 100 is illustrated. This allows the first exterior 2 to be fixed to the case body 1 at four locations provided at approximately equal intervals by the screw fixing portion 14 provided at the "3 o’clock position" and "9 o’clock position" in the timepiece 100 and the fastening projecting portion 16 provided at the "12 o’clock position" and "6 o’clock position" in the timepiece 100.

The opening on one side of the case body 1 in the vertical direction, the front surface side of the case body 1 (the visible side in the timepiece), is closed by the windshield 3. The windshield 3 is a transparent windshield formed, for example, of glass material or transparent resin material. The shape of the windshield 3 is not limited, but the windshield 3 in the embodiment has a substantially spherical shape with a raised center (see FIGS. 1 and 6). As shown in FIG. 1, in the embodiment, a parting member 4 is placed at the opening on the front surface side of the case body 1, and the windshield 3 is attached to the opening of the case body 1 through the parting member 4. The parting member 4 is not an essential component. The opening on the back surface side of the case body 1 (non-visible side of the timepiece, the lower side in FIG. 1) is closed by a back cover member 8. The back cover member 8 may be integrally formed with the case body 1.

The hollow portion inside the case body 1 constitutes a storage space for various components. A module 7 is located in the hollow portion inside the case body 1. The module 7 is a functional part that operates the timepiece 100, including, for example, a board and various electronic components not shown in the figures. The detailed illustration of module 7 is omitted in FIG. 1 and the like (in FIGS. 5, 6, and 7, the module 7 is indicated by a double-dashed line). A dial plate 6 is superposed on the upper side of the module 7 (the front surface side of the timepiece, the visible side) within the case body 1. A through hole 61 is formed in the center of the dial plate 6, and a hand shaft 71 protruding from the module 7 side is inserted through the through hole 61. At least one hand 62 is supported on the free end side of the hand shaft 71 (the upper end side in the height direction of the timepiece 100). FIG. 1 illustrates a case in which three hands 62 are supported on the hand shaft 71. The three hands 62 are, for example, the hour hand, minute hand, and second hand. The hand 62 is not limited to this. In each figure other than FIG. 1, the hand 62 is omitted.

The first exterior 2 is a ring-shaped member located on one side of the case body 1 in the vertical direction, which is the "first direction" to the case body 1. In the embodiment, one side in the vertical direction is the front surface side of the case body 1 (the visible side in the timepiece, the upper side in FIGS. 1 and 2), the same side where the windshield 3 is located. In the embodiment, the windshield 3 is located between the ring-shaped first exterior 2 and the case body 1. The first exterior 2 is made of various synthetic resins, for example. The ring-shaped first exterior 2 has a ring member 21 and first protrusions 22 protruding a predetermined length from a plurality of locations along the circumferential direction of the ring member 21 toward the center of the ring member 21. In the embodiment, the first protrusion 22 functions as an hour character that serves as an indicator when displaying the time by the hand 62. It is preferable that the first protrusion 22 be provided in four or more locations in order to fully serve as an indicator and to protect the aforementioned windshield 3. The illustration shows a case in which 12 first protrusions 22 are provided at approximately equal intervals along the circumferential direction of the ring member 21 from the 12 o'clock position to the 11 o'clock position in the timepiece 100. However, the number and arrangement of the first protrusions 22 are not limited to the illustrated example. For example, the first protrusion 22 may be provided at four locations such as "12 o’clock position," "6 o’clock position," "3 o’clock position," and "9 o’clock position" in the timepiece 100.

In the assembled state, the first protrusion 22 of the first exterior 2 is located over the windshield 3 from the ring member 21 side when the first exterior 2 is viewed from the "first direction" upward. That is, the first protrusion 22 overhangs from the base end fixed to the ring member 21 toward the center of the ring member 21 and on or above the top of the windshield 3, protruding along the surface of the windshield 3. Therefore, in the timepiece 100 of the embodiment, the first exterior 2 (the first protrusion 22 of the first exterior 2) constitutes the outermost exterior of the front surface side (upper side) of the timepiece 100. In other words, in the timepiece 100 of the embodiment, the first protrusion 22 of the first exterior 2 is located at the outermost location of the timepiece 100. The extent to which the first protrusion 22 overhangs on or above the windshield 3 is a matter that can be set as needed, taking design and other factors into consideration. However, as mentioned above, the first protrusion 22 preferably not cover the hand 62, since it functions as the hour character. Specifically, as for the overhang of the first protrusion 22, it may hang over some of the long hands (e.g., second and minute hands) that extend to the vicinity of the outer circumferential edge of the dial plate 6, but preferably not over the short hands (e.g., hour hand). As mentioned above, the windshield 3 in the embodiment has a spherical shape with a raised center, and the first protrusion 22 has an arc-shaped curve in the lateral view to follow the surface shape of the windshield 3. The shape of the windshield 3 is not limited to the illustrated example. If the surface of the windshield 3 is flat, the first protrusion 22 will also be straight, not curved. In FIGS. 5 and 7, the windshield 3 is omitted to show the shape of the first protrusion 22 for clarity.

The ring-shaped first exterior 2 of the embodiment has a second protrusion 23 protruding on the other side of the first direction (i.e., on the back side of the case body 1, the lower side in FIGS. 1 and 2). The second protrusion 23 is the portion that is screwed and fixed to the cylindrical case body 1 together with the second exterior 5 (first part 51 and second part 52 of the second exterior 5) described below, and has, at a position corresponding to the screw fixing portion 14 of the case body 1, a through hole 231 with a diameter that allows the screw fixing portion 14 to be inserted. The first exterior 2 is fastened to the case body 1 by inserting the screw fixing portion 14 through the through hole 231. Then, with the first part 51 and the second part 52 of the second exterior 5 as well as the first exterior 2 superposed in the screw fixing portion 14, screws 15 are inserted into the screw holes 141 of the screw fixing portion 14 and thereby the first exterior 2, the first part 51 and the second part 52 of the second exterior 5 are co-tightened and fixed to the case body 1.

Furthermore, the ring-shaped first exterior 2 in the embodiment has third protrusions 25 protruding on the other side of the first direction (i.e., on the back surface side of the case body 1, the lower side in FIGS. 1 and 2). The third protrusion 25 is fastened to the fastening projecting portion 16 of the case body 1 and has a through hole 251 at a position corresponding to the fastening projecting portion 16. The first exterior 2 is fastened to the case body 1 by insertion of the fastening projecting portion 16 into the through hole 251. The case body 1 of the embodiment is provided with screw fixing portions 14 at "3 o’clock position" and "9 o’clock position" in the timepiece 100, as described above, and with fastening projecting portions 16 at positions corresponding to "12 o’clock position" and "6 o’clock position" in the timepiece 100, which are offset from these positions by 45 degrees each. This allows the locations where the first exterior 2 is fastened to the case body 1 to be arranged at approximately even intervals along the circumferential direction of the case body 1, and the first exterior 2 can be more stably fastened to the case body 1. The screw fixing portions 14 and the fastening projecting portions 16 allow easy positioning of the first exterior 2 in the circumferential direction and also prevent misalignment and rotation in the circumferential direction.

The timepiece 100 is also equipped with a second exterior 5, which is located on the outer circumferential side of the cylindrical case body 1. In the embodiment, the second exterior 5 includes a first part 51 provided on one side of the outer circumferential side surface of the cylindrical case body 1 ("12 o'clock side" in the timepiece 100 in FIG. 1, etc.) and a second part 52 provided on the other side of the outer circumferential side surface of the cylindrical case body 1 ("6 o'clock side" in the timepiece 100 in FIG. 1, etc.). In the embodiment, the first part 51 is integrally provided with the first band 53, which is located on one side of the outer circumferential side surface of the case body 1 ("12 o’clock side" in the illustrated example), and the second part 52 is integrally provided with the second band 54, which is located on the other side of the outer circumferential side surface of the case body 1 ("6 o’clock side" in the illustrated example). Although the figure is omitted, the timepiece 100 can be worn on the user's arm, etc. by connecting the free ends of the first band 53 and the second band 54. In the embodiment, the second exterior 5 is formed by resin, such as urethane, for example. The materials used to form the second exterior 5 are not limited to these.

Of the second exterior 5, the first part 51 has fastening portions 511 fastened to the screw fixing portions 14 in the case body 1. In other words, in the embodiment, the fastening portions 511 are provided at the "3 o’clock position" and "9 o’clock position" on the timepiece 100 in the assembled state, respectively. Each fastening portion 511 has a through hole 511a with a diameter that allows insertion of the screw fixing portion 14 at a position corresponding to the screw fixing portion 14. Of the second exterior 5, the second part 52 has fastening portions 521 at the "3 o’clock position" and "9 o’clock position" in the timepiece 100 in the assembled state, corresponding to the screw fixing portions 14 in the case body 1, respectively. Each fastening portion 521 has a through hole 521a at a position corresponding to the screw hole 141 of the screw fixing portion 14. In the assembled state, the first exterior 2 and the second exterior 5 are screwed and fixed to the outer circumferential side surface of the cylindrical case body 1, and at the screw fixing location (the area to be screwed and fixed, "screw fixing location 150" indicated by a single dotted line in FIG. 6), the three layers of the fastening portion 511 of the first part 51 and the fastening portion 521 of the second part 52, which constitute the second exterior 5, and the second protrusion 23 of the first exterior 2 are superposed.

In the first part 51 and the second part 52 of the second exterior 5, the portions that surround the first exterior 2 in the assembled state have concave-convex fitting portions 55 corresponding to the shape of the top side of the first exterior 2. The concave-convex fitting portion 55 has the recessed portion corresponding to the first protrusion 22 of the first exterior 2 in the assembled state and has the projecting portion corresponding to the portion where there is no first protrusion 22. Avoiding the first protrusion 22, the concave-convex fitting portion 55 is placed on the top surface of the ring member 21 of the first exterior 2 (in FIG. 1, upper surface). This overlap of the concave-convex fitting portion 55 with at least a portion of the ring member 21 ensures that the first exterior 2 is prevented from exiting to the upper side.

Next, the action of the timepiece 100 according to the embodiment will be described. When assembling the timepiece 100 according to the embodiment, the module 7 and dial plate 6 are placed inside the case body 1, and the hands 62 are attached to the free end side of the hand shaft 71 that protrudes upward from the through hole 61 in the dial plate 6. A parting member 4 is placed on the upper side of the case body 1, and a windshield 3 is attached so as to close the upper opening of the case body 1. The lower opening of the case body 1 is closed by the back cover member 8.

The first exterior 2 is then installed first from the top of the windshield 3. At this time, the screw fixing portion 14 provided on the outer side surface of the case body 1 is inserted into the through hole 231 of the second protrusion 23. In addition, the fastening projecting portion 16 provided on the outer side surface of the case body 1 is inserted into the through hole 251 of the third protrusion 25 of the first exterior 2. This allows the first exterior 2 to be positioned in the circumferential direction with respect to the case body 1 and to be fastened in a manner that prevents it from rotating circumferentially. In this state, the first protrusion 22 of the first exterior 2, which overhangs from the ring member 21 side toward the center, is placed over the windshield 3 from the ring member 21 side. Each of the first protrusions 22 is located at the position as the hour character from the 12 o'clock position to the 11 o'clock position in the timepiece, respectively.

In addition, the first part 51 of the second exterior 5 with the first band 53 integrated into it is attached from the 12 o'clock side in the timepiece 100, and the second part 52 of the second exterior 5 with the second band 54 integrated into it is attached from the 6 o'clock side in the timepiece 100. At this time, to the screw fixing portion 14, where the second protrusion 23 of the first exterior 2 is fastened, the fastening portion 511 of the first part 51 is fastened so as to be superposed on the second protrusion 23. Specifically, the screw fixing portion 14 is inserted into the through hole 511a of the fastening portion 511. Then, the fastening portion 521 of the second part 52 is placed so as to be superposed on the second protrusion 23 and the fastening portion 511 on the screw fixing portion 14 where the second protrusion 23 of the first exterior 2 and the fastening portion 511 of the first part 51 are fastened, the screw 15 is inserted into the through hole 521a in the fastening portion 521 from the outside, and the screw 15 fixes the range from the fastening portion 521 to the screw hole 141 of the screw fixing portion 14 of the case body 1.

This results in the first exterior 2 and second exterior 5 (first part 51 and second part 52 of the second exterior 5) being co-tightened by the screws 15 to the case body 1 at the "screw fixing locations 150" shown in FIG. 6. When installing the first and second parts 51 and 52, respectively, the position is adjusted so that each concave-convex fitting portion 55 fits with the shape on the top surface of the first exterior 2, and the concave-convex fitting portion 55 presses at least a portion of the ring member 21 of the first exterior 2 from the top side. This means that when the first exterior 2 and second exterior 5 are fixed to the case body 1, the first exterior 2 cannot be removed to the upper side. In addition, operation buttons 12 are attached from the outside of the second exterior 5 at four locations on the timepiece 100: "2 o’clock position", "4 o’clock position", "8 o’clock position", and "10 o’clock position". This completes the timepiece 100.

In such a timepiece 100, since the outermost exterior of the top side is the second protrusion 23 of the first exterior 2, even if the timepiece 100 is dropped from the top side (front surface side), etc., the second protrusion 23 of the first exterior 2 contacts the floor or other surface first to absorb the shock, and the windshield 3 is not directly shocked. As a result, the windshield 3, which is formed of glass or other material, is not easily broken or scratched, and the appearance of the timepiece 100 is maintained.

As described above, in this embodiment, the timepiece 100 has a cylindrical case body 1 along a first direction (up-down direction in the embodiment), a ring-shaped first exterior 2 disposed on one side of the case body 1 in the first direction (up in the embodiment, the visible side of the timepiece). The ring-shaped first exterior 2 has a ring member 21 and first protrusions 22 protruding from a plurality of locations along the circumferential direction of the ring member 21 by a predetermined length toward the center of the ring member 21, the first protrusion 22 of the first exterior 2 being located at the outermost side of the timepiece 100. Here, the bezel described in the aforementioned JP H01-141485 (U) is arranged to surround the outer circumference of the windshield ("timepiece glass") of the timepiece, and the outermost exterior of the timepiece on the visible side is the windshield. Since the windshield is made of glass, etc., when placed on the outermost part of the timepiece, the windshield is easily broken or scratched when the timepiece is dropped or the like. However, according to the timepiece 100 disclosed in this embodiment, since the timepiece 100 has the above configuration, the first protrusion 22 of the first exterior 2 becomes the outermost exterior of the upper side (visible side) of the timepiece 100, and when the timepiece 100 is dropped from the upper side (visible side), the first protrusion 22 of the first exterior 2 first hits the floor surface, etc. and absorbs the impact. For example, even when a windshield 3, etc. made of glass, etc. is provided on the visible side of the timepiece 100, direct impact to the windshield 3, etc. is prevented, making it difficult for the windshield 3, etc. to be broken or damaged, and the appearance of the timepiece 100 is maintained.

In addition, the first protrusion in the embodiment is the hour character. This allows the timepiece 100 to have a shock-absorbing effect on components that an analog timepiece would almost certainly have.

The embodiment also has a windshield 3 located on one side of the case body 1 in the first direction (the upper side in the embodiment, the visible side of the timepiece) and between the ring-shaped first exterior 2 and the case body 1, and each first protrusion 22 of the ring-shaped first exterior 2 is located over the windshield 3 from the ring member 21 side when the ring-shaped first exterior 2 is viewed from first direction. This causes the first protrusion 22 of the first exterior 2 to be placed upper than the windshield 3 and become the outermost exterior on the upper side (visible side) of the timepiece 100. Therefore, even if the timepiece 100 is dropped from the upper side (visible side), the first protrusion 22 first hits the floor or other surface to absorb the shock and prevent the windshield 3 from cracking or being damaged.

The first protrusion 22 in the embodiment protrudes along the surface of the windshield 3. For example, when the surface of the windshield 3 is spherical as in the embodiment, the first protrusion 22 is formed in an arc shape along it, so that when an external impact is applied, the first protrusion 22 makes contact with the windshield 3 on a surface, and the impact concentrated on one point against the windshield 3 can be avoided.

In the embodiment, the timepiece 100 has a second exterior 5 that is located on at least a portion of the outer circumferential side of the cylindrical case body 1. The first exterior 2 and the second exterior 5 are co-tightened and fixed to the cylindrical case body 1 with screws 15. Therefore, one screw 15 can be used to fix one location, reducing the number of parts and man-hours required.

The ring-shaped first exterior 2 of the embodiment has second protrusions 23 protruding on the other side of the first direction (the lower, non-visible side of the timepiece in the embodiment), and each second protrusion 23, together with the second exterior 5, is screwed and fixed to the cylindrical case body 1. This allows positioning at the second protrusions 23 and co-tightening fixation with screws 15.

In the embodiment, the second exterior 5 includes a first part 51 provided on one side of the outer circumferential side surface of the cylindrical case body 1 and a second part 52 provided on the other side of the outer circumferential side surface of the cylindrical case body 1. The first exterior 2 and the second exterior 5 are screwed and fixed to the outer circumferential side surface of the cylindrical case body 1. In each screwed and fixed area ("screw fixing location 150" in FIG. 6), the first part 51 and the second part 52, which constitute the second exterior 5, and the first exterior 2 are superposed on three layers. This allows the three components to be fixed with a single screw 15 for one location, reducing the number of parts and man-hours required.

In the embodiment, the first part 51 is integrally provided with the first band 53, which is located on one side of the outer circumferential side surface of the cylindrical case body 1, and the second part 52 is integrally provided with the second band 54, which is located on the other side of the outer circumferential side surface of the cylindrical case body 1. This makes it possible to fix the bands (first band 53, second band 54) simply and efficiently.

Although an embodiment of the present disclosure is described above, it is needless to say that the present disclosure is not limited to the embodiment and various changes can be made without departing from the scope of the present disclosure.

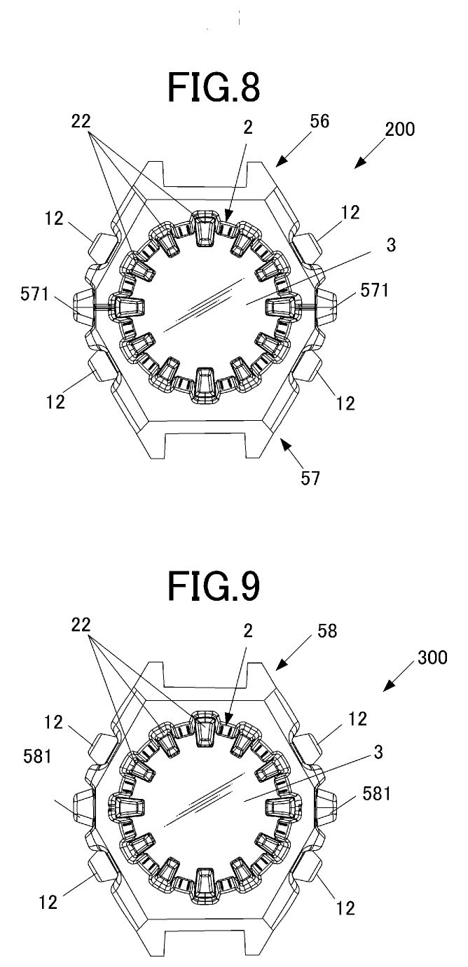

For example, in the above embodiment, the second exterior includes a first part 51 and a second part 52, and the first part 51 is integrally provided with a first band 53 and the second part 52 is integrally provided with a second band 54. However, it is sufficient that the second exterior is located on at least a portion of the outer circumferential side of the cylindrical case body 1 and thus the configuration and location of the second exterior are not limited to those illustrated in the embodiments. For example, as in the timepiece 200 shown in FIG. 8, the second exterior may consist of a first bezel member 56 attached to 12 o'clock side in the timepiece 200 and a second bezel member 57 attached to 6 o'clock side in the timepiece 200, which are separate from the band. In this case, too, the first exterior 2 and the first bezel member 56 and the second bezel member 57 which are the second exterior, are co-tightened and fixed to the cylindrical case body 1 with screws 15. In other words, at each "screw fixing location 150" (see FIG. 6), the three layers of the second protrusion 23 of the first exterior 2 and fastening portions (not shown) of the first bezel member 56 and the second bezel member 57, which are the second exterior, are superposed and screwed and fixed.

Furthermore, as in the timepiece 300 shown in FIG. 9, for example, the second exterior may be a nearly ring-shaped bezel member 58 that is separate from the band. In this case, too, the first exterior 2 and the bezel member 58, which is the second exterior, are co-tightened and fixed to the cylindrical case body 1 by means of screws 15, but at each "screw fixing location 150" (see FIG. 6), two layers of the second protrusion 23 of the first exterior 2 and a fastening portion (not shown) of the bezel member 58, which is the second exterior, are superposed and screwed and fixed. In both cases of the timepiece 200 shown in FIG. 8 and the timepiece 300 shown in FIG. 9, the configuration other than the second exterior is the same as that shown in the embodiment.

In the above embodiment, a case is shown in which the timepiece 100 is an analog-type timepiece equipped with hands 62, and the time is indicated by the hands 62. However, the timepiece is not limited to an analog-type timepiece, but may display the time, etc. in a digital format with a liquid crystal display, etc., or may be a hybrid-type timepiece with both analog and digital displays. If the timepiece is a digital system for displaying the time, the first protrusion of the first exterior 2 does not have to function as an hour character and may overhang toward the windshield 3 even longer toward the center of the timepiece than shown in the illustration. In this case, the effect of protecting the windshield 3 can be further expected.

The above embodiment describes a case in which the timepiece 100 has a windshield 3 and the first protrusion 22 of the first exterior 2 protrudes from the outer circumferential side of the case body 1 toward the center to protect the windshield 3, but it is not essential that the timepiece 100 have a windshield 3. The timepiece 100 need only be provided with the first protrusion 22 protruding toward the center from the outer circumferential side of the case body 1, for example, the first protrusion 22 may be provided to overhang above the dial plate 6. In this case, the first protrusion 22 overhangs from the outer circumferential side toward the center, preventing damage to the dial plate 6, the parts of module 7 located under the dial plate 6, etc.

The timepiece is not limited to having only a timepiece function, but may also be equipped with various functions such as a pedometer, heart rate monitor, altimeter, barometer, etc., or may be a so-called smart watch.

Although some embodiments of the present disclosure have been described above, the scope of the present disclosure is not limited to the embodiments described above, but includes the scope of the disclosure described in the claims and their equivalents.

This application claims the benefit of Japanese Patent Application No. 2024-187311, filed on October 24, 2024 which is hereby incorporated by reference in its entirety.

1. A timepiece comprising:
a case with an opening; and
a first exterior located at the opening of the case, wherein
the first exterior includes a ring-shaped first member located on or above the case and a first protrusion protruding toward a center of the first member from a plurality of locations along a circumferential direction of the first member, and
the first protrusion of the first exterior is located at an outermost location of the timepiece.

2. The timepiece according to claim 1, wherein the first protrusion is an hour character.

3. The timepiece according to claim 1, further comprising a windshield that is at least partially located between the first exterior and the case, wherein
at least a portion of the first protrusion of the first exterior is located on or above the windshield.

4. The timepiece according to claim 3, wherein the first protrusion protrudes along a surface of the windshield.

5. The timepiece according to claim 1, further comprising a second exterior that is located on an outer circumferential side of the case, wherein
the first exterior and the second exterior are co-tightened and fixed to a cylindrical case by a screw.

6. The timepiece according to claim 5, wherein
the first exterior has a second protrusion protruding from a first protrusion side to a case side, and
the second protrusion and the second exterior are co-tightened and fixed to the cylindrical case by the screw.

7. The timepiece according to claim 5, wherein
the second exterior includes a first part on one side of an outer circumferential side surface of the case and a second part on the other side of the outer circumferential side surface of the cylindrical case,
the first exterior and the second exterior are screwed and fixed to the outer circumferential side surface of the cylindrical case, and
three layers of the first exterior and the first part and the second part forming the second exterior are superposed in an area to be screwed and fixed.

8. The timepiece according to claim 7, wherein
the first part is integrally provided with a first band that is located on one side of the outer circumferential side surface of the cylindrical case, and
the second part is integrally provided with a second band that is located on one side of the outer circumferential side surface of the cylindrical case.

9. The timepiece according to claim 1, wherein the first protrusion of the first exterior is located at the outermost location of the timepiece in a direction from a case side to a first protrusion side.

10. The timepiece according to claim 2, further comprising a windshield that is at least partially located between the first exterior and the case, wherein
at least a portion of the first protrusion of the first exterior is located on or above the windshield.

11. The timepiece according to claim 10, wherein the first protrusion protrudes along a surface of the windshield.

12. The timepiece according to claim 2, further comprising a second exterior that is located on an outer circumferential side of the case, wherein
the first exterior and the second exterior are co-tightened and fixed to a cylindrical case by a screw.

13. The timepiece according to claim 12, wherein
the first exterior has a second protrusion protruding from a first protrusion side to a case side, and
the second protrusion and the second exterior are co-tightened and fixed to the cylindrical case by the screw.

14. The timepiece according to claim 12, wherein
the second exterior includes a first part on one side of an outer circumferential side surface of the case and a second part on the other side of the outer circumferential side surface of the cylindrical case,
the first exterior and the second exterior are screwed and fixed to the outer circumferential side surface of the cylindrical case, and
three layers of the first exterior and the first part and the second part forming the second exterior are superposed in an area to be screwed and fixed.

15. The timepiece according to claim 14, wherein
the first part is integrally provided with a first band that is located on one side of the outer circumferential side surface of the cylindrical case, and
the second part is integrally provided with a second band that is located on one side of the outer circumferential side surface of the cylindrical case.

16. The timepiece according to claim 2, wherein the first protrusion of the first exterior is located at the outermost location of the timepiece in a direction from a case side to a first protrusion side.

17. The timepiece according to claim 3, further comprising a second exterior that is located on an outer circumferential side of the case, wherein
the first exterior and the second exterior are co-tightened and fixed to a cylindrical case by a screw.

18. The timepiece according to claim 3, wherein the first protrusion of the first exterior is located at the outermost location of the timepiece in a direction from a case side to a first protrusion side.
